(19) United States
(12) Patent Application Publication
(10) Pub. No.: US 2007/0182112 A1
(43) Pub. Date: Aug. 9, 2007

(54) Cart with cam-action handle

(76) Inventor: Alex Weiss, Sisters, OR (US)

Correspondence Address: GLENN C. BROWN, PC, 777 NW WALL STREET, SUITE 308, BEND, OR, 97701, US

(21) Appl. No.: 11/703,481

(22) Filed: Feb. 7, 2007

Related U.S. Application Data
(60) Provisional application No. 60/771,511, filed on Feb. 7, 2006.

(51) Int. Cl. B62B 1/00

(52) U.S. Cl. 280/47.18

(57) ABSTRACT

A cart having a handle and axle assembly, and which is operable to raise and lower the cart by moving the handle between a raised and lowered position.

### RELATED APPLICATIONS

This application claims priority to U.S. Ser. No. 60/771,511, filed Feb. 7, 2006, and which is incorporated by reference in its entirety.

### BACKGROUND OF THE INVENTION

This invention relates to a cart that can be used for landscaping and other general uses, and which incorporates features that accommodate easy loading and unloading of the cart.

Homeowners, landscapers and others must routinely collect and move yard debris and landscaping materials to and from a work area. Various designs of nonpowered carts and wheelbarrows are known for these uses, all of which include a hopper of some sort, wheels and a handle.

These various designs require the materials to be lifted from the ground and deposited into the hopper, or the hopper must be tilted to place one edge near the ground in order to load the hopper. In each instance lifting and loading the material renders the job more laborious and time-consuming. Those of limited strength or endurance are challenged by the physical demands of the lifting and loading of the material, and in any event the loading takes longer and is rather inefficient.

A need therefore exists for an improved cart design that permits ready and easy loading of various materials from the ground into a cart for moving the material from place to place, and which reduces the strength required to load the materials into the hopper.

### SUMMARY OF THE INVENTION

This invention provides a solution to the unmet needs in the prior art by providing a cart that can be readily raised and lowered for loading and unloading, and which includes an operable handle that provides a mechanical advantage to the user, reducing the effort required to raise and lower the loaded cart. In particular a cart according to preferred embodiments of the invention include an operable lever-cam-axle mechanism that permits the cart to be lowered to ground level for loading, and then raised to roll the loaded cart. In another aspect of the invention the cart includes a removable front wall that when removed, permits material to be pushed directly into the lowered cart without the need to lift the material either to a raised hopper or over a hopper wall.

These and other features of the invention will be described in greater detail by reference to the drawings.

### BRIEF DESCRIPTION OF THE DRAWINGS

FIG. 1 is a left side elevational view of a preferred embodiment of the invention showing the cart in its raised position.

FIG. 2 is a left side elevational view of a preferred embodiment of the invention showing the cart in its lowered position.

FIG. 3 is a top view of the embodiment shown in FIG. 1 showing the cart in the raised position.

FIG. 4 is a top view of the embodiment shown in FIG. 1 showing the cart in the lowered position.

### DETAILED DESCRIPTION OF PREFERRED EMBODIMENTS

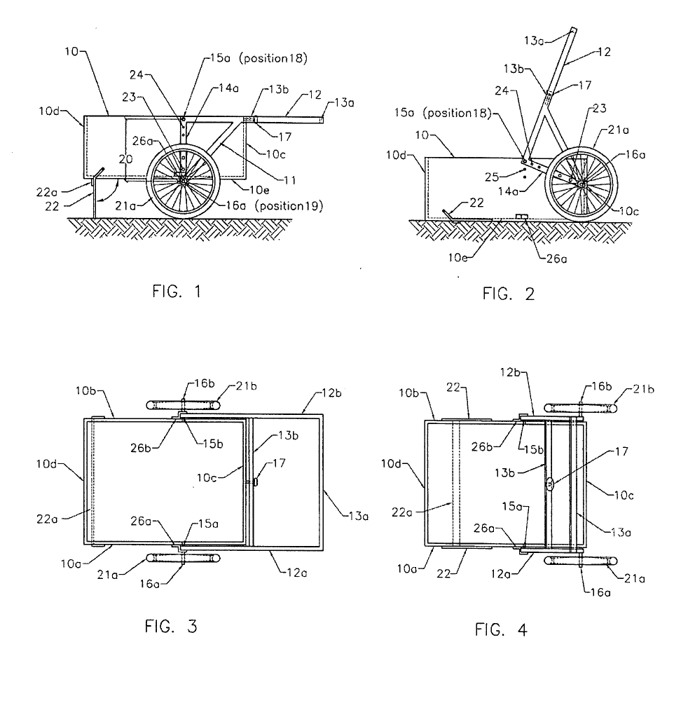

Referring now to FIGS. 1-4, a cart according to the invention is shown generally at 10. FIGS. 1 and 2 illustrate the left side of the cart; the right side is a mirror image of the illustrated left side and the following description applies to the right side as well. Cart 10 includes side walls 10a and 10b, rear wall 10c, optional front wall 10d, and a floor 10e. Cart 10 includes handle assembly 11 that consists of side members 12a and 12b, cam mechanisms 14a and 14b, upper pivots 15a and 15b, and axles 16a and 16b which define lower pivot points 19a and 19b respectively. Lever 12 includes two side members 12a and 12b connected at or near their ends by a lateral member 13a and also incorporating cross brace 13b.

Cart includes cam assemblies 14a and 14b. Cam assembly 14a is illustrated and cam assembly 14b is similar although “hidden” in the drawing as the view is from the left side. Cam assemblies 14a and 14b are connected to respective side members 12a and 12b. Cam mechanisms 14a and 14b contain pivots 15a and 15b, and receive axles 16a and 16b in one of threaded holes 24. Position 18 refers to the location of pivots 15a and 15b on the side walls of the cart, 10a and 10b. Position 19 refers to the location of the axles 16a and 16b on cam mechanisms 14a and 14b, respectively.

Handle side members 12a and 12b are extendable to allow for increased leverage. Cross brace 13b is adjustable. It can to be mounted at a variable distance from rear wall 10c along side handle members 12a and 12b to allow for clearance around hopper 10. In one preferred embodiment a locking device 17 is incorporated into handle cross brace 13b. Each side of the handle 11 is mounted through pivots 15a and 15b on respective side walls 10a and 10b at a position 18 on the sidewall. Position 18 is variable as alternate mounting locations are provided for pivots 15a and 15b on both cam mechanisms 14a and 14b and side walls 10a and 10b.

Cam assemblies 14a and 14b include axles 16a and 16b on which are mounted wheels 21a and 21b respectively. Each axle is mounted on its cam mechanism at a position 19. Position 19 is variable as alternate mounting locations are provided for axles 16a and 16b on the cam assemblies 14a and 14b.

Distance 20 is the space between pivots 15a and 15b and axles 16a and 16b. Distance 20 can be varied by changing the location (position 18) of pivots 15a and 15b and/or by changing the location (position 19) of axles 16a and 16b. The particular arrangement of handle 11, its lever, cam, pivot mounting points, and axle mounting points provides for a unique combination of features in a cart according to preferred embodiments of the invention. In general the design permits the cart to be raised and lowered by operation of handle 11 between a first position (FIG. 1) and a second position (FIG. 2). Lowering the cart allows for easy loading, raising the cart allows for easy rolling on relatively large wheels.

Referring again to the drawings, cart 10 can be lowered to place floor 10e directly on the ground by moving handle 11 to its raised position. When cart 10 is in its lowered position, the floor of the cart rests directly on the ground. A user can load material directly into the cart through an open front section, or if a removable or hinged front wall 10d is provided, by removal or lowering of front wall 10d. Loading the cart in the lowered position avoids the necessity to lift materials into the cart, and makes the cart much easier to load, representing a significant advantage over existing cart designs. Once the cart is loaded, the user moves handle 11 from its raised position as shown in FIG. 2 to the lowered position shown in FIG. 1. Owing to the novel design of handle 11, doing so raises the cart body off the ground as the wheels are rotated around pivot position 18. In addition to raising the cart, the wheels also provide an additional advantage by rolling under the cart as it is raised, further easing the raising of the cart.

Cam mechanisms 14a and 14b have alternate mounting points for pivots 15a and 15b as well as axles 16a and 16b. Adjustments to distance 20 are accomplished by moving the location (position 18) of the pivots 15a and 15b and/or the location (position 19) of axles 16a and 16b. In the position shown in FIGS. 1 and 2, the distance is maximized to provide the maximum ground clearance for the cart. In this position, however, the effective leverage length used to raise the loaded cart is at its maximum, and the effective mechanical advantage provided by the handle assembly is at its minimum.

For heavier loads, this effective mechanical advantage might not be sufficient to comfortably raise the loaded cart. If so, the mechanical advantage of the handle can be increased by moving pivots 15a and 15b closer to axles 16a and 16b. This can be accomplished by moving either pivots 15a and 15b or axles 16a and 16b. Doing so reduces distance 20, and increases the mechanical advantage of handle 11. The numerous mounting positions available permit a wide variety of combinations of leverage and ground clearance distances.

A foldable, adjustable leg 22, with cross brace 22a, is attached at cart side walls 10a and 10b. This permits the cart to stand firmly and stably when raised. The legs are adjustable to match the preferred ground clearance.

When the handle 11 is in its lowered position it is preferably clamped into place by an operable lever or clamp 17. Doing so permits the handle to be partially raised to tilt the cart for dumping the contents. In this way the handle can also be used to push and steer the cart. Additional stability is provided by brackets 26a and 26b, which are mounted on respective hopper walls 1a and 10b, and which receive axles 16a and 16b outboard of cam mechanisms 14a and 14b, and which resist any spreading forces exerted on handle 11 or wheels 21a and 21b by weight of the load in the hopper.

Referring again to the drawings, it can be seen that handle 12 connects directly to the axle of each wheel, and transmits pushing and steering forces directly to the axle of each of the wheels. This feature of the invention reduces stress on the cart itself since essentially no pushing or steering forces are transmitted through the body of the cart. At the same time the handle assembly locks the cart and wheels securely into position relative to one another, making a more stable and rigid cart.

A cart and handle according to the invention can be made of any suitable material, including metal, polymeric materials, wood, or any other suitable material. In addition, those of skill in the art will recognize that the invention as described can be changed in detail and arrangement without departing from the scope of the invention.

1. A cart comprising:
a hopper;
a handle assembly pivotally mounted on the hopper;
pair of wheels mounted on the handle assembly;
the handle assembly having a first position wherein the wheels support the hopper above an underlying surface; and,
the handle operable to a second position wherein the wheels are retracted and the hopper is resting on the underlying surface.

2. A cart according to claim 1 wherein the handle includes:
a rear cross member;
left and right wheel supports pivotally mounted on the hopper; and,
left and right side members connecting the respective left and right wheel supports to the rear cross member.

3. A cart according to claim 2 wherein the left and right wheel supports are oriented at an angle of about 90 degrees relative to the respective left and right side members.

4. A cart according to claim 2 wherein the left and right wheels are mountable at a plurality of preselected positions on the respective left and right wheel supports, each preselected position selected to support the hopper at a predetermined height above the underlying surface when the handle is in the first position.

5. A cart according to claim 2 wherein the hopper can be pivotally mounted at a plurality of preselected positions to the left and right wheel supports.

6. A cart according to claim 1 further comprising a retractable stand mounted on the hopper and operable to support the hopper.

7. A cart according to claim 1 further comprising left and right brackets mounted on the hopper and positioned to receive the respective left and right axles when the handle is moved to the first position.

8. A cart according to claim 1 further comprising a clamp to secure the handle cross member to the hopper when the handle is in the first position.

9. A cart according to claim 4 further comprising left and right axles rotatably supporting the respective left and right wheels and each of which includes a threaded distal end; and,
wherein the plurality of preselected positions are defined by a plurality of threaded holes in the left and right wheel supports.

10. A cart according to claim 1 wherein the hopper includes a removable front wall.

11. A cart according to claim 1 wherein the handle side members are extendable.
